(19) United States
(12) Patent Application Publication
(10) Pub. No.: US 2014/0251516 A1
(43) Pub. Date: Sep. 11, 2014

(54) RIMLESS WHEEL

(71) Applicant: Pamela Burns, Douglas (GB)

(72) Inventor: Alan Burns, Douglas (GB)

(73) Assignee: ALBERT TECHNOLOGY LIMITED, Braddan, Isle of Man (GB)

(21) Appl. No.: 14/113,191

(22) PCT Filed: Apr. 19, 2012
(86) PCT No.: PCT/GB12/50854

§ 371 Date: Apr. 30, 2014

(30) Foreign Application Priority Data
Apr. 19, 2011 (GB) 1106572.9

(51) Int. Cl. B60B 15/02; B60B 19/00

(52) U.S. Cl. CPC B60B 15/02; B60B 19/00
USPC 152/5; 29/894.3; 156/60; 156/227

(57) ABSTRACT

The invention relates to a rimless vehicle wheel comprising a hub and a plurality of cantilevered blades spaced around the hub. Each blade has an inner root extending from the hub, an outer tip, and first and second major blade surfaces extending between the root and tip. Each blade has a stiffness allowing independent flexure, along at least part of its length, between a first unloaded blade configuration and any number of second loaded blade configurations. The depth of at least one blade from front to back in the meridian plane measured proximate the blade tip is greater than the same measurement proximate the blade root. The blades are adapted to flex in the circumferential plane of the wheel. Multi-part sleeves are adhered to the blade tips so as to provide a sacrificial wearing surface.

The present invention relates to a rimless wheel and particularly, but not exclusively, to a bladed wheel for land-based and/or amphibious and/or waterborne vehicles.

It is well known to provide a land-based vehicle with a wheel arrangement dependent on the type of terrain over which the vehicle is expected to travel. In particular, certain vehicle types used for industrial, agricultural, recreational and military purposes are commonly provided with bespoke tyre tread and/or wheel-and-track arrangements to facilitate the propelling of vehicles over given surface types ranging from firm, flat ground to rough, uneven, soft or steeply inclined terrain. It is also known to adapt conventional road vehicles to enable them to be temporarily driven over snow and/or ice covered surfaces. Typically this involves the employment of specially adapted winter snow tyres having a larger contact patch, special siped tread patterns, imbedded stud arrangements, or bespoke elastomeric compositions, each for the purpose of increasing cohesion with the underlying surface.

Furthermore, it is also known to provide hybrid wheels fitted with paddle blades for the dual purpose of propelling an amphibious vehicle both through water and over land.

However, the aforementioned wheel types suffer from several disadvantages. For example, they are unsuitable for propelling vehicles satisfactorily over a wide range of different surface types. In particular, wheels adapted for specific surface terrain types may require vehicles to be provided with complicated suspension and gearing arrangements. Furthermore, certain wheel types are vulnerable to mechanical damage or punctures.

The invention disclosed in the applicant's co-pending patent application (PCT/GB2010/052016) proposes a radical alternative to conventional vehicle wheels which overcomes many of the aforementioned limitations. This is achieved by providing a rimless vehicle wheel comprising a plurality of flexible cantilevered blades arranged around a central hub whereby each blade has a stiffness allowing independent flexure, thus providing enhanced traction and suspension performance as a vehicle moves over a variety of underlying surface types.

Despite representing a significant breakthrough in terms of wheel design, there remain several shortcomings associated with the applicant's prior invention. For example, the wheel geometry tends to limit its application to larger industrial type vehicles and/or vehicles which have been significantly modified to accommodate its flexible blades. Furthermore, it has been observed that the blade tips tend to damage softer ground, e.g. turf lying beneath shallow snow. Conversely, when used on harder ground surfaces, the elastomeric material—which provides the required flexibility to the blades—tends to abrade rapidly thus limiting the useful life of the wheel. Accordingly, there is a further requirement for a vehicle wheel which overcomes at least some of these remaining shortcomings.

According to a first aspect of the present invention, there is provided a rimless vehicle wheel comprising:
(i) a hub;
(ii) a plurality of cantilevered blades spaced around the hub, each blade having an inner root extending from the hub, an outer tip, and first and second major blade surfaces extending between the root and tip;
wherein each blade is formed from a material of a first type and has a stiffness allowing independent flexure, along at least part of its length, between a first unloaded blade configuration and any number of second loaded blade configurations;
wherein the depth of at least one blade from front to back in the meridian plane measured proximate the blade tip is greater than the same measurement proximate the blade root; and wherein the blades are adapted to flex in the circumferential plane of the wheel.

Optionally, the blade tip defines a generally T-shaped blade in the meridian plane.

Optionally, the blade tip defines a generally T-shaped blade which is asymmetric in the meridian plane.

Optionally, a sacrificial material of a second type is connected to the outer tip of each blade on its first and/or second major blade surfaces.

Optionally, when in the first unloaded blade configuration, each blade extends substantially radially from the hub, and the first and second major blade surfaces are substantially planar along their lengths between the root and tip.

Optionally, when in any of the second loaded blade configurations, at least part of the outer tip of each blade is moved out of radial alignment with its inner root, and the first and second major blade surfaces are curved under load between the root and tip.

Optionally, the length of each blade from root to tip is between 3% and 20% of the circumference of the hub measured at the blades' inner roots.

Optionally, the depth of each blade from front to back in the meridian plane measured at the blade root is between 70% and 160% of the length of each blade from root to tip.

Optionally, the width of each blade in the circumferential plane tapers towards its outer tip.

Optionally, a reinforcing web extends circumferentially between adjacent blades proximate the hub.

Optionally, the depth of the reinforcing web from front to back in the meridian plane is between 5% and 10% of the depth of each blade from front to back in the meridian plane measured at the blade root.

Optionally, each reinforcing web is triangular in shape in the circumferential plane.

Optionally, the hub is provided with between fourteen and twenty four cantilevered blades.

Optionally, the hub and the cantilevered blades are integrally moulded from an elastomeric material.

Alternatively, the hub and the cantilevered blades are moulded from an elastomeric material as separate parts for subsequent assembly.

Optionally, the elastomeric material is a polyurethane plastics material.

Optionally, the sacrificial material comprises an elastomeric material.

Optionally, the elastomeric material is a synthetic and/or natural rubber.

Optionally, the sacrificial material is bonded to each blade tip by means of an adhesive.

Alternatively, or additionally, the sacrificial material is connected to each blade tip by means of mechanical fasteners.

According to a second aspect of the present invention, there is provided a method of attaching a multi-part sleeve of sacrificial material to a blade of a rimless vehicle wheel according to the first aspect, the method comprising the steps of:
(i) providing a rimless vehicle wheel according to the first aspect wherein the depth of at least one blade from front to back in the meridian plane measured proximate the blade tip is greater than the same measurement proximate the blade root;
(ii) providing a multi-part sleeve wherein the individual sleeve parts are dimensioned such that, when combined, they are larger than the blade tip when measured at its deepest part in the meridian plane;
(iii) positioning one or more first sleeve part(s) so as to overlap a first major blade tip surface;
(iv) positioning one or more second sleeve part(s) so as to overlap a second major blade tip surface and superimpose the one or more first sleeve part(s); and fastening together all superimposed peripheral edges of the first and second sleeve part(s) which extend beyond the corresponding peripheral edges of the enlarged blade tip.

Optionally, the method is modified such that:
step (ii) involves providing a two-part sleeve wherein each sleeve part comprises first and second major surfaces each being peripherally connected by a common web, and wherein the said surfaces are each dimensioned so as to be larger than the blade tip when measured at its deepest part in the meridian plane;
step (iii) involves positioning a first sleeve part such that its common web locates proximate a first junction between the blade and its enlarged blade tip; folding the first sleeve part about the common web so as to superimpose its first and second major surfaces and overlap the corresponding first and second major blade tip surfaces; and fastening together all superimposed peripheral edges of the first sleeve part which extend beyond the corresponding peripheral edges of the enlarged blade tip; and
step (iv) involves positioning a second sleeve part such that its common web locates proximate a second junction between the blade and its enlarged blade tip; folding the second sleeve part about the common web so as to superimpose its first and second major surfaces and overlap the first and second major surfaces of the first sleeve part; and fastening the second sleeve part to the first sleeve part.

Optionally, the step of fastening together all superimposed peripheral edges is achieved by applying an adhesive between the respective superimposed sleeve parts.

Optionally, the step of fastening the second sleeve part to the first sleeve part is achieved by applying an adhesive between the respective overlapping sleeve parts.

According to a third aspect of the present invention, there is provided a passenger vehicle comprising at least one rimless wheel according to the first aspect.

Optionally, the vehicle is a land-based vehicle.

Alternatively, the vehicle is an amphibious vehicle.

Alternatively, the vehicle is a waterborne vehicle.

Embodiments of the present invention will now be described, by way of example only, with reference to the accompanying drawings, in which:

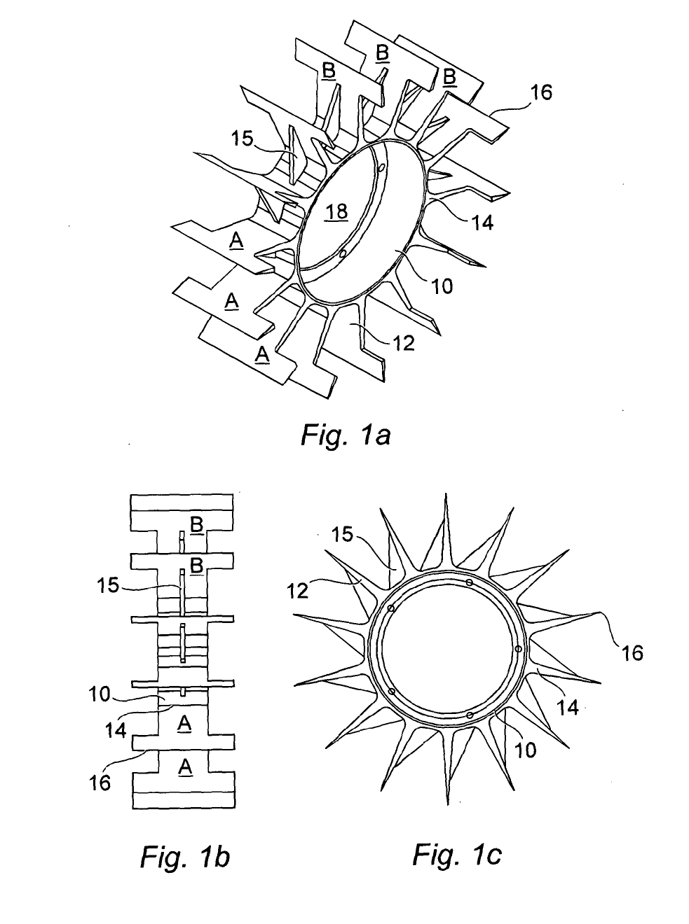

FIG. 1a is a schematic isometric view of a rimless wheel according to the present invention with all blades in a non-deflected state;

FIG. 1b is an end elevation view of the wheel of FIG. 1a;

FIG. 1c is a side elevation view of the wheel of FIG. 1a;

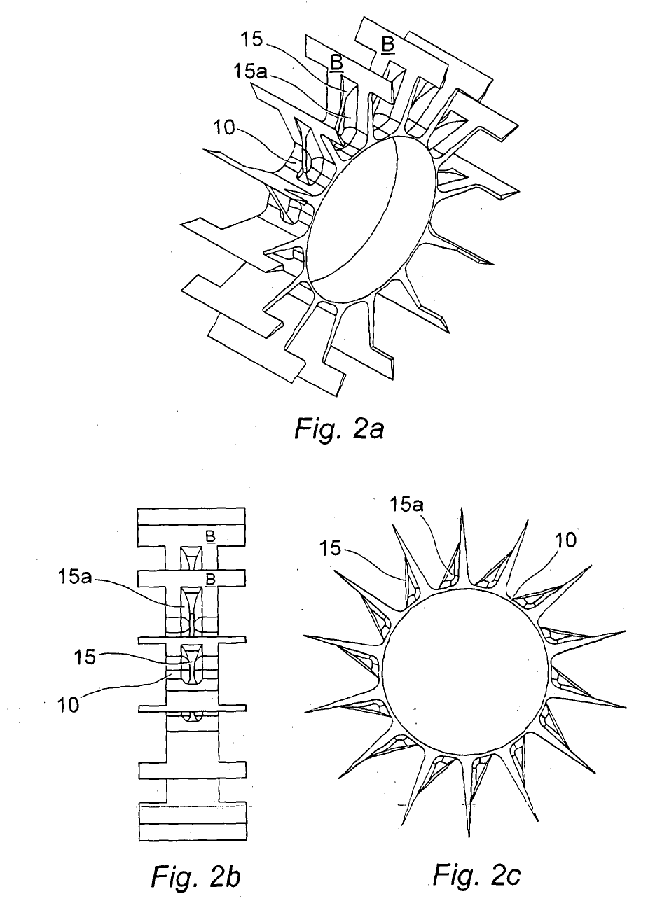

FIG. 2a is a schematic isometric view of an alternative wheel according to the present invention with all blades in a non-deflected state;

FIG. 2b is an end elevation view of the wheel of FIG. 2a;

FIG. 2c is a side elevation view of the wheel of FIG. 2a;

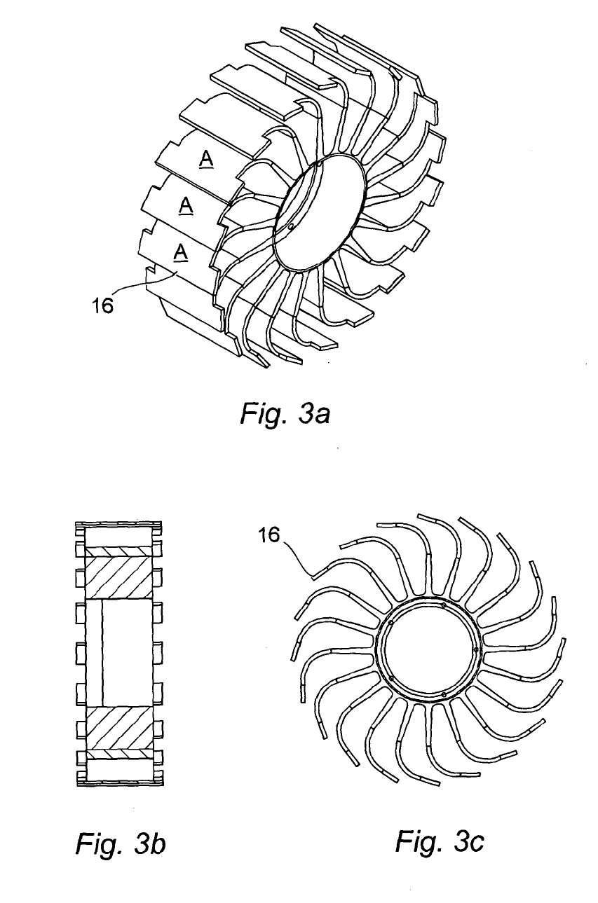

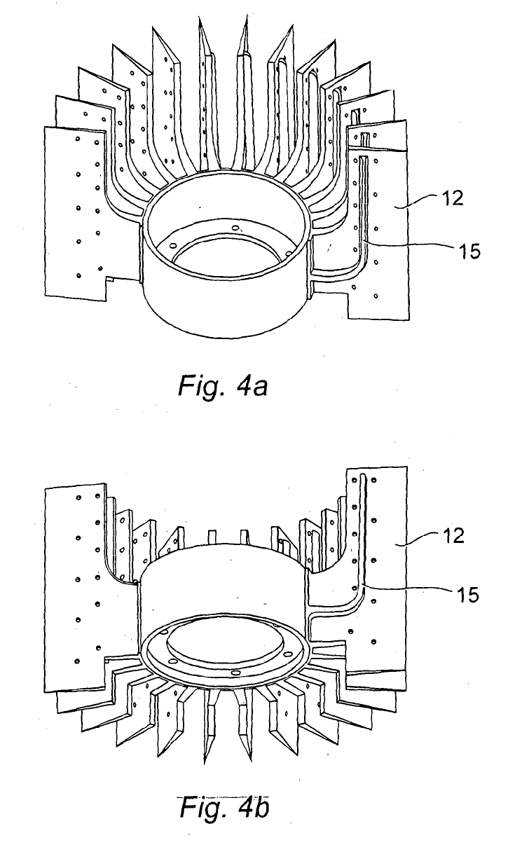

FIG. 3a is a schematic isometric view of a wheel according to the present invention with all blades in a deflected state;

FIG. 3b is an end elevation view of the wheel of FIG. 3a;

FIG. 3c is a side elevation view of the wheel of FIG. 3a;

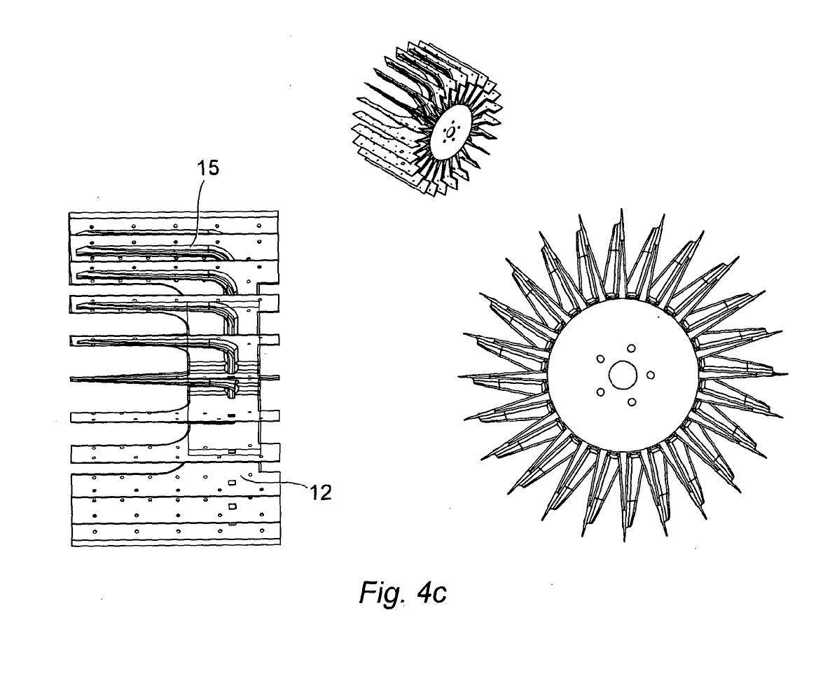

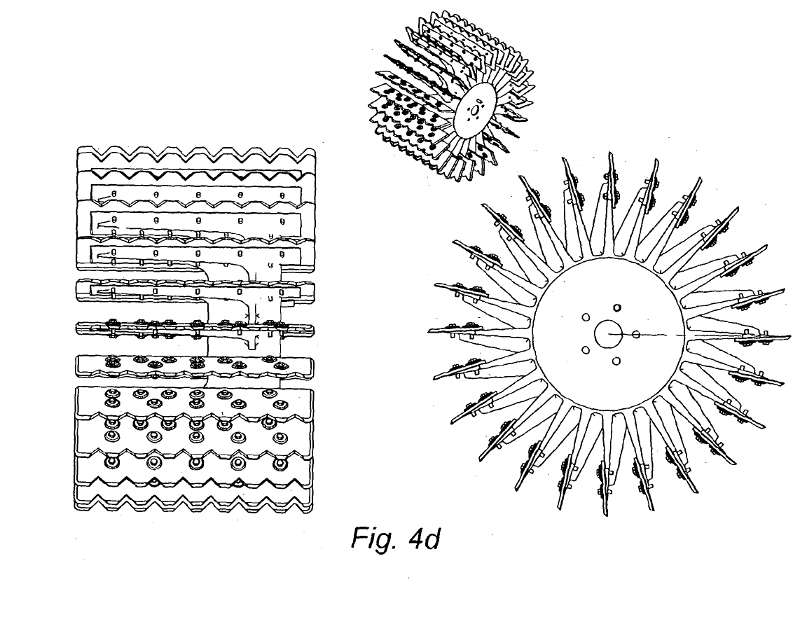

FIG. 4a is a partial schematic perspective view of a further alternative wheel according to the present invention comprising an asymmetric T-shaped blade;

FIG. 4b is a partial schematic perspective view of the wheel of FIG. 4a from another angle;

FIG. 4c is schematic isometric, end elevation and side elevation view of the wheel of FIGS. 4a/b;

FIG. 4d is schematic isometric, end elevation and side elevation view of the wheel of FIGS. 4a/b having sacrificial sleeves attached to its enlarged blade tips;

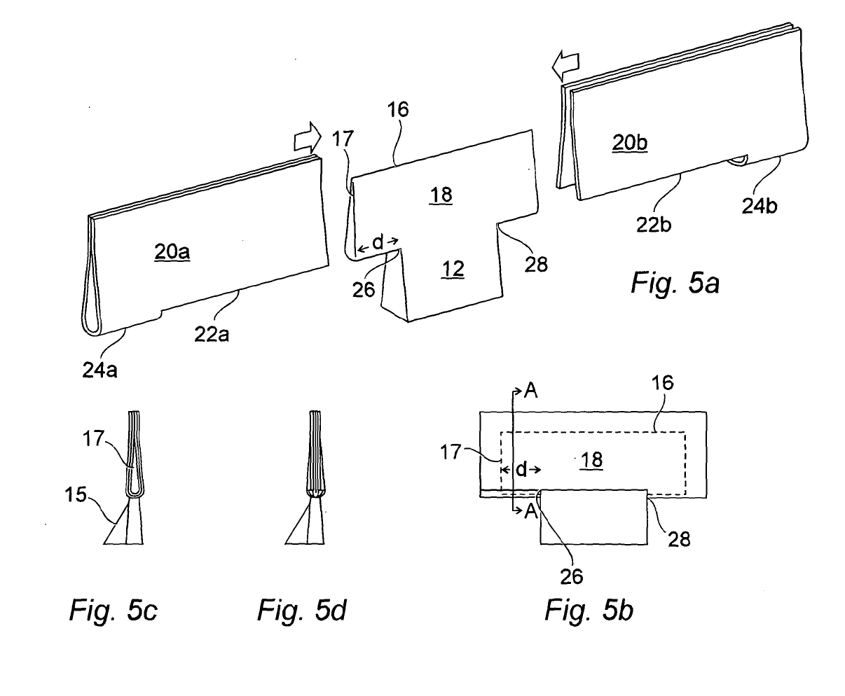

FIG. 5a is an exploded partial schematic view of an enlarged blade tip, and a two-part sleeve of sacrificial material for encapsulating the blade tip;

FIG. 5b is a schematic view of the enlarged blade tip of FIG. 5a when viewed in the meridian plane showing the two-part sleeve in position;

FIG. 5c is a schematic sectional view along A-A of the enlarged blade tip of FIG. 5b; and

FIG. 5d is a schematic end view of the enlarged blade tip of FIG. 5b.

FIGS. 1a-c show an unloaded wheel comprising an annular hub portion 10 and having fourteen identical blades 12 extending radially outwards from the hub portion 10 and distributed evenly around its circumference. The wheel may be cast or injection moulded in one piece, or a series of distinct parts, from a polyurethane plastics material and mounted on a metal wheel hub. Each blade 12 has a length in the radial direction measured from its connection to the hub 10 at an inner root portion 14 to an outer tip 16. The hub 10 and blades 12 each have a depth in the axial direction. The depth of the blades 12 measured at their outer tips 16 is greater than the corresponding measurement at their inner roots 14 such that the blade has an enlarged rectangular portion proximate its tip 16 which defines an overall T-shaped blade in the meridian plane. The length—measured in the radial direction—of the enlarged portion shown in FIGS. 1a-c is approximately 28% of the entire blade length from root 14 to tip 16. The inner surface of the hub portion 10 defines a cylindrical passage 18. Each blade 12 is provided with first and second major blade surfaces A, B facing corresponding surfaces A, B of an adjacent blade 12.

A generally triangular and planar reinforcing web 15 is provided between adjacent major blade surfaces A, B. As shown most clearly in FIG. 1c, the reinforcement web 15 extends radially outwardly from the outer surface of the hub 10 along a portion of the length of each major blade surface B towards the blade tips 16. As best shown in FIG. 1b, the reinforcing web 15 lies in a plane (hereinafter, the circumferential plane) orientated perpendicularly with respect to the meridian plane and the wheel's rotational axis, and lying coincident with the midpoint along the blade depth. It will be appreciated that such an arrangement limits the degree of flexure along the length of each blade 12 and imparts additional strength to wheels which are subject to higher applied tension and/or compression loads during use.

FIGS. 2a-c show an alternative embodiment wherein the connection between the reinforcing web 15, the outer surface of the hub 10, and each major blade surface B is defined by curved surfaces 15a which blend into one another. It will be appreciated that the strength imparted by the reinforcing web 15 can be varied by altering its thickness and/or the number of webs used between adjacent blades and/or the thickness of the curved surfaces 15a.

Each blade surface A, B shown in FIGS. 1a-c and 2a-c is substantially planar along its length between its inner root portion 14—which blends into the hub portion 10—and its outer tip 16. The width of each blade 12 in the circumferential plane is less than its depth in the meridian plane and tapers from its inner root portion 14 towards its outer tip 16.

The measurements of the particular wheel exemplified by the embodiment of FIGS. 1a-c are: wheel diameter=811 mm; hub (outer) diameter=410 mm; hub (outer) circumference=1288 mm; blade length=200.5 mm; blade depth (at root)=130 mm; blade depth (at tip)=265 mm; length (measured in radial direction) of enlarged portion at blade tip=55.5 mm; Density: 1.14 g/cc; Hardness: 95A Shore; Elongation at Break: 450%; Flexural Modulus: 0.0758 GPa; Tear Strength: 133 kN/m.

In each of the aforementioned embodiments, since each blade 12 is long relative to its width in the circumferential plane, its cantilevered connection allows a degree of flexure relative to the hub portion 10 as exemplified in FIGS. 3a-c. Of course, in practice only those blades 12 which are in contact with an underlying surface will be deflected during rotation of the rimless wheel.

The elastomeric material from which the wheel is formed is selected to provide an appropriate stiffness to each blade 12 allowing a degree of independent flexure out of its natural (unloaded) radial configuration relative to the hub portion 10. Whilst the dimensions of each blade 12 dictate that flexure is permitted principally in the circumferential plane, a degree of flexure in the meridian plane is not precluded. Any flexure of a blade 12 in the circumferential plane imparts a corresponding curve to its major blade surfaces A, B, as is exemplified in FIGS. 3a-c. The presence of a reinforcing web (not present in FIGS. 3a-c) along part of a blade's length will of course constrain the degree of flexure and/or limit it to the outer tip 16.

The stiffness or compliance of the blades 12 and the presence of an applied load, i.e. resulting from an applied torque (in the clockwise direction) and vehicle weight, each cause the radius of the wheel to become locally reduced. The local reduction in radius is caused by a relative rotation between the hub 10 and those blades 12 which are in contact with an underlying surface. This leads to their partial collapse so as to support the wheel on an underlying surface terrain (not shown) by the outer portions of their major blade surfaces A. The collapsed outer portions of the blades 12 are partially overlapped in the radial direction and their major blade surfaces A, B curve in use to varying extents to present an overall increased contact area with the underlying surface terrain. As best seen in FIG. 3a, the contact area of the overlapping outer portions of the major blade surfaces present a relatively large contact area to the underlying surface terrain, thereby serving to improve the traction and braking of land-based vehicles. Indeed, the square shape of the outer tip 16 of each blade presents a larger, more efficient contact area which can deform better around uneven objects with minimal loss of traction. Furthermore, because each blade 12 has a consistently reducing taper from its inner root portion 14 towards its outer tip 16 this helps to distribute loads more evenly along the portion of the blade contacting the underlying surface terrain, and thus provides for better suspension and more even wear characteristics along each blade surface. The specific geometry of the taper can be adjusted according to variables such as the weight of the vehicle and the expected torque loads it will experience. Advantageously, no internal stiffeners are required within each blade.

Whilst the T-shaped blades 12 shown in FIGS. 1-3 are symmetrical in the meridian plane, asymmetrical blade configurations are also possible. For example, FIGS. 4a-c show schematic views of a rimless wheel provided with asymmetric T-shaped or anvil-shaped blades 12. Furthermore, the reinforcing web 15 of each T-shaped or anvil-shaped blade 12 extends radially away from the hub 10 before curving around 90 degrees to extend axially along the majority of the longer part of the enlarged portion of the blade 12. Such an asymmetric arrangement can be advantageous where rimless wheels are retro-fitted to existing vehicles. In particular, the asymmetric blades 12 provide an increased lateral reach and contact area with the underlying surface as compared to a given vehicle's standard tyres.

In order to address the problems of rapid abrasion of the polyurethane blades 12 and the damage caused to softer ground, each blade may be provided with a sleeve of sacrificial elastomeric material. The sleeve of sacrificial material may be attached by nuts and bolts as shown in FIG. 4d, although alternative mechanical fasteners such as rivets, staples etc, are of course also possible. Alternatively, each sleeve is constructed in two parts from a natural or synthetic rubber material and is specifically designed to fit over the enlarged outer tip 16 of each blade 12. This is illustrated in FIGS. 5a-d.

FIG. 5a shows the distal end of a blade 12 which tapers towards its outer tip 16. The enlarged blade portion 18 proximate the blade tip 16 is wedge-shaped and defines an overall T-shaped blade 12. The sleeve is constructed from two similarly sized parts 20a, 20b, each part having first and second major faces A, B which are similar in shape to the enlarged blade portion 18, but each dimensioned to be larger in the meridian plane, i.e. larger in both the axial (depth) direction and the radial (length) directions. The first and second major faces A, B of each part are connected proximate a peripheral edge 22a, 22b by a common connecting web 24a, 24b. The depth d of the connecting web 24a, 24b in the axial direction is selected so as to be greater than the depth d of the “overhang” between a lateral edge of blade 12 and the corresponding lateral edge 17 of its enlarged portion 18.

The two-part sleeve is assembled over the enlarged portion 18 of the blade 12 as follows. A first sleeve part 20a is positioned such that the innermost edge of its connecting web 24a abuts against the blade edge proximate a first junction 26 between the blade 12 and its enlarged tip portion 18. The first sleeve part 20a is folded about its connecting web 24a so as to superimpose its first and second major faces A, B and overlap the corresponding faces of the enlarged tip portion 18. In doing so, the top and side peripheral edges of the first sleeve part extend beyond the corresponding peripheral edges of the underlying enlarged tip portion 18 of the blade 12. The superimposed top and side peripheral edges of the first sleeve part which extend beyond the corresponding peripheral edges of the enlarged blade tip are then fastened together, preferably by means of an adhesive.

A second sleeve part 20b is positioned such that the innermost edge of its connecting web 24b abuts against the opposing blade edge proximate a second junction 28 between the blade 12 and its enlarged tip portion 18. The second sleeve part 20b is folded about its connecting web 24b so as to superimpose its first and second major faces A, B and overlap the second and first major surfaces B, A of the first sleeve part 20a. The second sleeve part 20b is then fastened to the first sleeve part 20a over their entire area of overlap, preferably by means of an adhesive. Since the second sleeve part 20b fully overlaps the first sleeve part 20a, the second sleeve part is necessarily slightly larger than the first sleeve part 20a.

The above arrangement ensures that the entire surface of the enlarged blade tip 18 is fully encapsulated within the sleeve of sacrificial material. Consequently, side (sheer) stresses are eliminated during use of the rimless wheel thus obviating the need for any additional mechanical attachment of the sleeve to the blade 12.

In use, land-based vehicles employing wheels in accordance with the present invention enjoy numerous advantages as compared to conventional wheels arrangements. Firstly, the wheels of the present invention present a significantly greater contact area against the underlying surface terrain as described above with reference to FIGS. 3a-c. Increased contact area enables superior traction whilst spreading applied pressure on the underlying surface terrain. This combined with the sacrificial sleeve on the enlarged blade portions 18 serves to reduce localised compaction or damage to the underlying surface. A reduced environmental impact is particularly important in agricultural settings where compacted soil is undesirable, or on virgin surfaces such as fragile botanical growth in desert areas. Traction can be further improved by applying traction-enhancing surface textures to one or both major surfaces A, B of each sacrificial sleeve. Indeed, the traction-enhancing surface textures may replicate the treads of conventional vehicle wheels.

The inherent resilience of the blades 12 results in a natural suspension providing a smoother, more cushioned ride for passengers whilst complementing, or obviating the need for, separate vehicle suspension mechanisms. Another advantage of the resilience of the blades 12 is that they are capable of a degree of twisting along their length. Since the wheels of the present invention do not require inflation, they are resistant to damage and punctures are not an issue.

The bladed rimless wheels of the present invention also provide a flexible solution capable of use of a wide variety of different makes and models of consumer passenger vehicles. For example, the blades can be shaped and dimensioned so as to correspond with overall footprint of the conventional tyres intended for any given vehicle. This ensures that little, if any, modification to the vehicle is required in order to accommodate the rimless vehicle wheels according to the present invention. Indeed, it is envisaged that a common hub and blade arrangement could be provided for a wide range of vehicle types, with bespoke sacrificial sleeves being provided to adapt the shape and balance of the wheels in accordance with the specific requirements of the vehicle in question.

Modifications and improvements may be made to the foregoing without departing from the scope of the invention as defined by the accompanying claims. For example, the embodiments of FIGS. 1a-c, 2a-c, 3a-c, 4a and 4b could be varied in terms of their dimensions or their materials; or indeed individual features of the different embodiments may be interchanged or combined.

Whilst the length—measured in the radial direction—of the enlarged blade portion shown in FIGS. 1a-c is approximately 28% of the entire blade length from root 14 to tip 16, this can be varied to be up to 50% of the entire blade length.

Whilst the first and second junctions—against which the common connecting webs of the two-part sleeves lie against—are illustrated as being right angled corners in FIGS. 5a and 5b, it will be appreciated that other arrangements are also possible such as acute, obtuse or curved junctions.

Although only a single reinforcement web 15 is provided between adjacent blades in FIGS. 1a-c, 2a-c and 4a-b, the presence of multiple webs is not excluded. Whilst the reinforcing web 15 in FIGS. 4a/b curves around an angle of 90 degrees, other angles are not excluded. Indeed, multiple reinforcement webs 15 may be present which fan out across a blade at various angles. Similarly, the reinforcement webs 15 shown in FIGS. 1a-c and 2a-c need not extend only in the radial direction.

Whilst the illustrated embodiments show a plastics hub 10 formed integrally with the blades 12, it is also envisaged that the blades may be separately and directly attached to the inner metallic wheel hub. The term “hub” should therefore be understood to encompass both possibilities, i.e. a plastics hub, or a metallic hub.

1. A rimless vehicle wheel comprising:
a hub;
a plurality of cantilevered blades spaced around the hub, each blade having an inner root extending from the hub, an outer tip, and first and second major blade surfaces extending between the inner root and the outer tip;
wherein each blade is formed from a material of a first type and has a stiffness allowing independent flexure, along at least part of its length, between a first unloaded blade configuration and any number of second loaded blade configurations;
wherein a depth of at least one blade from front to back in Ua meridian plane measured proximate the outer tip is greater than the same measurement proximate the blade root; and
wherein the plurality of cantilevered blades are adapted to flex in a circumferential plane of the rimless vehicle wheel.

2. The rimless vehicle wheel according to claim 1, wherein the outer tip defines a generally T-shaped blade in the meridian plane.

3. The rimless vehicle wheel according to claim 1, wherein, the outer tip defines a generally T-shaped blade which is asymmetric in the meridian plane.

4. The rimless vehicle wheel according to claim 1, wherein a sacrificial material of a second type is connected to the outer tip of each blade on at least one of the first and the second major blade surfaces.

5. The rimless vehicle wheel according to claim 1, wherein when in the first unloaded blade configuration, each blade extends substantially radially from the hub, and the first and second major blade surfaces are substantially planar along their lengths between the inner root and the outer tip.

6. The rimless vehicle wheel according to claim 1, wherein when in any of the second loaded blade configurations, at least part of the outer tip of each blade is moved out of radial alignment with its inner root, and the first and second major blade surfaces are curved under load between the inner root and the outer tip.

7. The rimless vehicle wheel according to claim 1, wherein a length of each blade from the inner root to the outer tip is between 3% and 20% of a circumference of the hub measured at the inner root.

8. The rimless vehicle wheel according to claim 1, wherein the depth of each blade from front to back in the meridian plane measured at the inner blade root is between 70% and 160% of a length of each blade from the inner root to the outer tip.

9. The rimless vehicle wheel according to claim 1, wherein a width of each blade in a circumferential plane tapers towards the outer tip.

10. The rimless vehicle wheel according to claim 1, wherein a reinforcing web extends circumferentially between adjacent blades proximate the hub.

11. The rimless vehicle wheel according to claim 10, wherein a depth of the reinforcing web from front to back in the meridian plane is between 5% and 10% of a depth of each blade from front to back in the meridian plane measured at the inner root.

12. The rimless vehicle wheel according to claim 10, wherein each reinforcing web is triangular in shape in the circumferential plane.

13. The rimless vehicle wheel according to claim 1, wherein the hub comprises between fourteen and twenty four cantilevered blades.

14. The rimless vehicle wheel according to claim 1, wherein the hub and the plurality of cantilevered blades are integrally moulded from an elastomeric material.

15. The rimless vehicle wheel according to claim 1, wherein the hub and the plurality of cantilevered blades are moulded from an elastomeric material as separate parts for subsequent assembly.

16. The rimless vehicle wheel according to claim 14, wherein the elastomeric material is a polyurethane plastics material.

17. The rimless vehicle wheel according to claim 4, wherein the sacrificial material comprises an elastomeric material.

18. The rimless vehicle wheel according to claim 17, wherein the elastomeric material is at least one of a synthetic and a natural rubber.

19. The rimless vehicle wheel according to claim 4, wherein the sacrificial material is bonded to each blade tip by an adhesive.

20. The rimless vehicle wheel according to claim 4, wherein, the sacrificial material is connected to the outer tip by mechanical fasteners.

21. A method of attaching a multi-part sleeve of sacrificial material to a blade of a rimless vehicle wheel according to claim 1, the method comprising:
(i) providing a rimless vehicle wheel wherein a depth of at least one blade from front to back in the meridian plane measured proximate the outer tip is greater than the same measurement proximate the inner root;
(ii) providing a multi-part sleeve wherein the individual sleeve parts are dimensioned such that, when combined, the individual sleeve parts are larger than the blade tip when measured at a deepest part in the meridian plane;
(iii) positioning one or more first sleeve parts so as to overlap a first major blade tip surface;
(iv) positioning one or more second sleeve parts so as to overlap a second major blade tip surface and superimpose the one or more first sleeve parts; and
fastening together all superimposed peripheral edges of the first and second sleeve parts which sleeve parts extend beyond the corresponding peripheral edges of the enlarged outer tip.

22. The method according to claim 21, wherein:
step (ii) comprises providing a two-part sleeve wherein each sleeve part comprises first and second major surfaces each being peripherally connected by a common web, and wherein the said surfaces are each dimensioned so as to be larger than the outer tip when measured at its deepest part in the meridian plane;
step (iii) comprises positioning a first sleeve part such that its common web locates proximate a first junction between the blade and its enlarged blade tip; folding the first sleeve part about the common web so as to superimpose its first and second major surfaces and overlap the corresponding first and second major blade tip surfaces; and fastening together all superimposed peripheral edges of the first sleeve part which extend beyond the corresponding peripheral edges of the enlarged blade tip; and
step (iv) comprises positioning a second sleeve part such that its common web locates proximate a second junction between the blade and its enlarged blade tip; folding the second sleeve part about the common web so as to superimpose its first and second major surfaces and overlap the first and second major surfaces of the first sleeve part; and fastening the second sleeve part to the first sleeve part.

23. The method according to claim 21, wherein the step of fastening together all superimposed peripheral edges is achieved by applying an adhesive between respective superimposed sleeve parts.

24. The method according to claim 22, wherein the step of fastening the second sleeve part to the first sleeve part is achieved by applying an adhesive between respective overlapping sleeve parts.

25. A passenger vehicle comprising at least one rimless wheel according to claim 1.

26. A passenger vehicle according to claim 25, wherein the vehicle is a land-based vehicle.

27. A passenger vehicle according to claim 25, wherein the vehicle is an amphibious vehicle.

28. A passenger vehicle according to claim 25, wherein the vehicle is a waterborne vehicle.
